(19) United States
(12) Patent Application Publication
(10) Pub. No.: US 2016/0020563 A1
(43) Pub. Date: Jan. 21, 2016

(54) CABLE CONNECTOR

(71) Applicant: ENERGY FULL ELECTRONICS, New Taipei City (TW)

(72) Inventor: Lingyuan Zhang, New Taipei City (TW)

(21) Appl. No.: 14/334,168

(22) Filed: Jul. 17, 2014

(51) Int. Cl. H01R 24/20

(52) U.S. Cl. CPC H01R 24/20

(57) ABSTRACT

A cable connector with a first body, a plurality of terminals, and a plurality of wires is provided. The first body comprises a plurality of first slots and a plurality of second slots. The terminals comprise a plurality of first terminals and a plurality of second terminals. Each of the first terminals and the second terminals comprises a contacting zone, a fixing zone, and a riveting zone. Each of the fixing zones is embedded in the first slots of the first body and the second slots of the first body from a back side of the first body. There are a plurality of first intervals between the riveting zones of the second terminals and a plurality of second intervals between the contacting zones of the second terminals, and the first intervals are larger than or equal to the second intervals.

### CROSS REFERENCE TO RELATED APPLICATION

This application claims the benefit of U.S. Provisional Patent Application Ser. No. 61/875393, filed Sep. 9, 2013.

### BACKGROUND OF THE INVENTION

1. Field of Invention

The invention relates to a cable connector, and more particularly, a process art of applying a riveting method to a SATA (Serial Advanced Technology Attachment) cable connector.

2. Description of Prior Art

A prior art skill of a cable connector is disclosed in TIPO (Taiwan Intellectual Property Office) Patent I257750 patent (the foreign patent families of the said Taiwan Patent are CN 1655408 A and U.S. Pat. No. 6,824,426 B1). FIG. 1 is an exploded schematic view of a cable connector of a prior art. The cable connector 100 comprises the wires 3 and terminals 2. The terminals 2 and wires 3 are connected by the welding method, and the welding method is very labor intensive.

### BRIEF SUMMARY OF THE INVENTION

The main purposes of the present invention are to provide a cable connector to dispose a riveting zone on each terminal relative to a connecting part of the wires, and to connect each terminal and each wire by the riveting method. Additionally, at least one bending zone is disposed in at least one of the terminal to facilitate the packaging process.

One of the main purposes of the present invention is to provide a cable connector which comprises a first body, a plurality of terminals, and a plurality of wires.

The first body comprises a plurality of first slots and a plurality of second slots. The terminals comprise a plurality of first terminals and a plurality of second terminals, each of the first terminals and the second terminals having a contacting zone, a fixing zone, and a riveting zone, and each of the fixing zones of the first terminals and the second terminals is embedded respectively in the first slots and the second slots of the first body from a back side of the first body. There are a plurality of first intervals between the riveting zones of the second terminals and a plurality of second intervals between the contacting zones of the second terminals, and the first intervals are larger than or equal to the second intervals.

The connecting parts of the wires are connected with the riveting zones of the corresponding terminals.

According to a preferred embodiment of the present invention, the second terminals further comprise a plurality of connecting zones between the riveting zones and the contacting zones of the second terminals. A length of the connecting zone of one of the second terminals and a length of the adjacent connecting zone are the same.

According to a preferred embodiment of the present invention, part of each of the second terminals between the connecting zone and the riveting zone is bending line shaped or curving line shaped.

According to a preferred embodiment of the present invention, at least one of the second terminals comprises at least one bending zone disposed between each of the connecting zones and each of the riveting zones in order to make each of the fixing zones and each of the riveting zones be on different horizontal planes.

According to a preferred embodiment of the present invention, the contacting zones of part of the first terminals are electrically connected with the riveting zones of part of the first terminals by the method of many to one.

According to a preferred embodiment of the present invention, the cable connector further comprises a back cover. The back cover comprises a plurality of guiding slots corresponding to the first terminals and the second terminals in order to make each of the first terminals and the second terminals be embedded respectively into each of the guiding slots.

According to a preferred embodiment of the present invention, a space between the second terminals, the fixing areas, and the first body is filled by colloid or the space is plugged by a back cover.

According to a preferred embodiment of the present invention, the back cover further comprises a plurality of projections, the projections are positionally in accordance with the first slots and the second slots.

Another of the main purposes of the present invention is to provide a cable connector which comprises a back cover, a first body, a plurality of terminals, and a plurality of wires.

The back cover comprises a plurality of projections. The first body comprises a plurality of first slots and a plurality of second slots. The terminals comprise a plurality of first terminals and a plurality of second terminals, each of the first terminals and the second terminals having a contacting zone, a fixing zone, and a riveting zone, and each of the fixing zones of the first terminals and the second terminals is embedded respectively in the first slots and the second slots of the first body from a back side of the first body. There are a plurality of first intervals between the riveting zones of the second terminals and a plurality of second intervals between the contacting zones of the second terminals, and the first intervals are larger than or equal to the second intervals. Each of the fixing zones and each of the riveting zones are disposed on different horizontal planes. The second terminals further comprise a plurality of connecting zones between the riveting zones and the contacting zones of the second terminals. A length of the connecting zone of one of the second terminals and a length of the adjacent connecting zone are the same. Each of the wires comprises a connecting part corresponding to one of the riveting zones of the first terminals and the second terminals, and a part of some of the wires are covered by insulating layers.

According to another preferred embodiment of the present invention, part of each of the second terminals between the connecting zone and the riveting zone is bending line shaped or curving line shaped.

According to another preferred embodiment of the present invention, at least one of the second terminals comprises at least one bending zone disposed between each of the connecting zones and each of the riveting zones in order to make each of the fixing zones and each of the riveting zones be on different horizontal planes.

According to another preferred embodiment of the present invention, the contacting zones of part of the first terminals are electrically connected with the riveting zones of part of the first terminals by the method of many to one.

According to another preferred embodiment of the present invention, the cable connector further comprises a back cover. The back cover comprises a plurality of guiding slots corresponding to the first terminals and the second terminals to make each of the first terminals and the second terminals be embedded respectively into each of the guiding slots.

According to another preferred embodiment of the present invention, a space between the second terminals, the fixing areas, and the first body is filled by colloid or the space is plugged by a back cover.

According to another preferred embodiment of the present invention, the back cover further comprises a plurality of projections, and the projections are positionally in accordance with the first slots and the second slots.

The advantage of the present invention is to solve the problem of riveting caused by small intervals between the terminals and the wires, and simplifying the cable connector assembly process.

### BRIEF DESCRIPTION OF THE DRAWINGS

FIG. 1 is an exploded schematic view of a cable connector of a prior art.

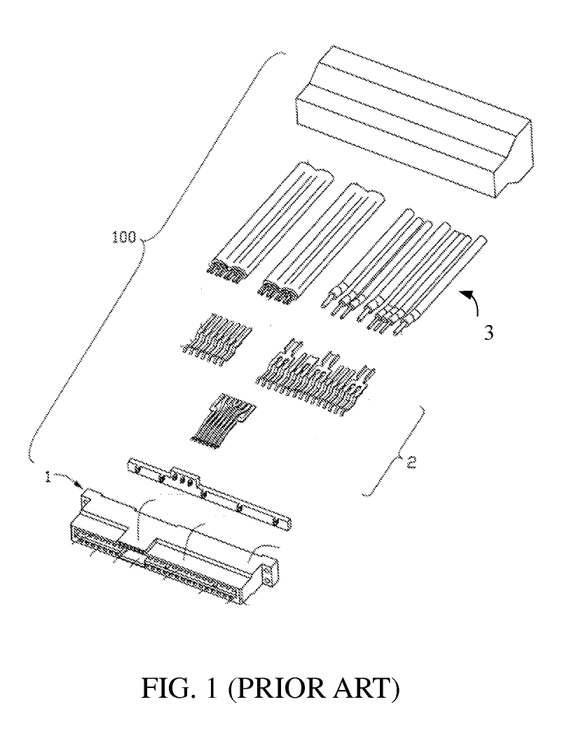

FIG. 2 is an exploded schematic view of a cable connector of a first preferred embodiment of the present invention.

FIG. 3 is a detailed structure drawing of the terminals in FIG. 2.

FIG. 4 is a detailed structure drawing of the second terminals in FIG. 2.

FIG. 5 is a detailed structure drawing of the riveting zones of the terminals of FIG. 2.

FIG. 6 is a packaged schematic view of a cable connector of a first preferred embodiment of the present invention.

### DETAILED DESCRIPTION OF THE PREFERRED EMBODIMENTS

The following descriptions of all embodiments, with reference to the accompanying drawings, are used to exemplify the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention.

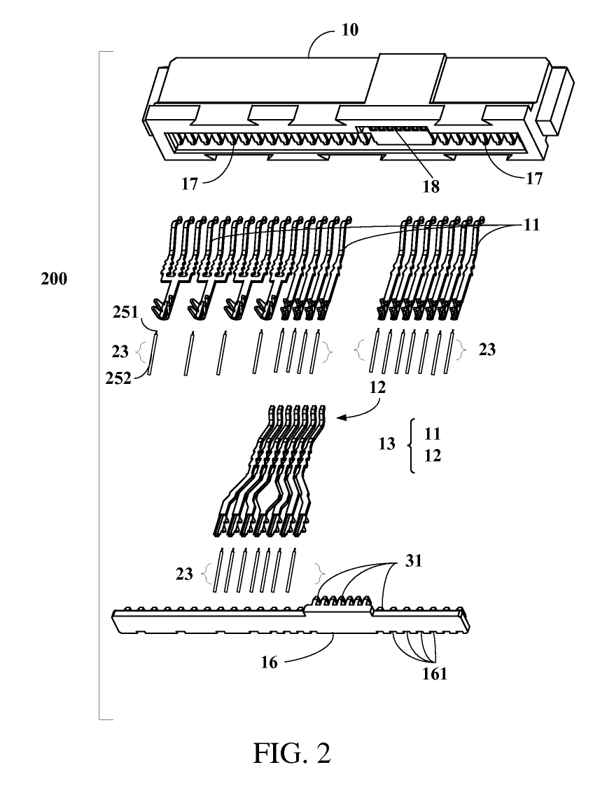

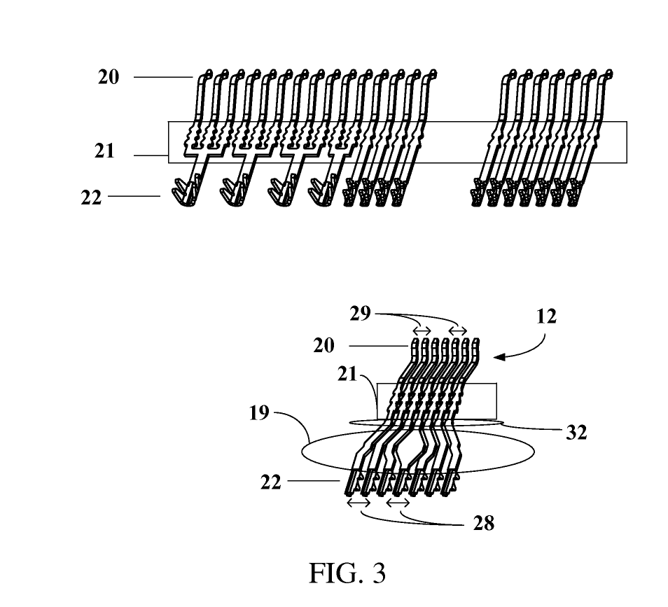

FIG. 2 is an exploded schematic view of a cable connector of a first preferred embodiment of the present invention. FIG. 3 is a detailed structure drawing of the terminals in FIG. 2. A cable connector 200 comprises a first body 10, a second body 15, a back cover 16, a plurality of terminals 13, and a plurality of wires 23.

The first body 10 comprises a plurality of first slots 17, a plurality of second slots 18, and a locking portion 26. The back cover 16 comprises a plurality of projections 31 and a plurality of guiding slots 161.

Each of the terminals 13 comprises a plurality of first terminals 11 and a plurality of second terminals 12. Each of the first terminals 11 and the second terminals 12 has a contacting zone 20, a fixing zone 21, and a riveting zone 22, and the first terminals 11 and the second terminals 12 are respectively in the first slots 17 and the second slots 18 of the first body 10.

The contacting zones 11 of part of the first terminals 11 are electrically connected with the riveting zone 22 of part of the first terminals 11 by the method of many to one.

There are a plurality of first intervals 28 between the riveting zones 22 of the second terminals 12 and a plurality of second intervals 29 between the contacting zones 20 of the second terminals 12, and the first intervals 28 are larger than or equal to the second intervals 29.

Moreover, the second terminals 12 further comprise a plurality of connecting zones 19 between the riveting zones 22 and the contacting zones 20 of the second terminals 12. A length of the connecting zone 20 of one of the second terminals 12 and a length of the adjacent connecting zone 20 are the same. Because the problems of signal transfer always come with the different lengths of the connecting zones 19, part of each of the second terminals 12 between the connecting zone 20 and the riveting zone 22 (the connecting zone 19) is bending line shaped or curving line shaped to make the lengths of the connecting zones 19 equal even the first intervals 28 and the second intervals 29 are different in lengths.

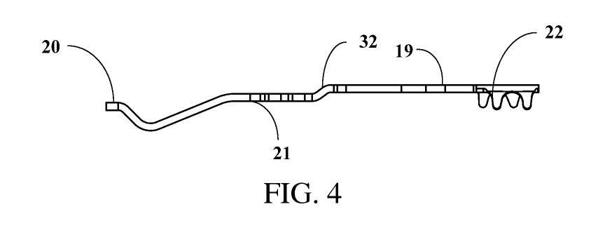

Referring to FIG. 4, FIG. 4 is a detailed structure drawing of the second terminals in FIG. 2. In the second terminals 12, two bending zones 32 are disposed between each of the fixing zones 21 and each of the connecting zones 19. By disposing the bending zones 32, each of the fixing zones 21 and each of the connecting zones 19 could be on different horizontal planes to facilitate the following packaging process.

Each of the wires 23 has a connecting part 251 to one of the riveting zones 22 of the corresponding terminals 13 (the first terminals 11 and the second terminals 12), and a part of some of the wires 23 are covered by insulating layers 252. The connecting parts 251 of the wires 23 are connected with the riveting zones 22 of the corresponding terminals 13 (the first terminals 11 and the second terminals 12).

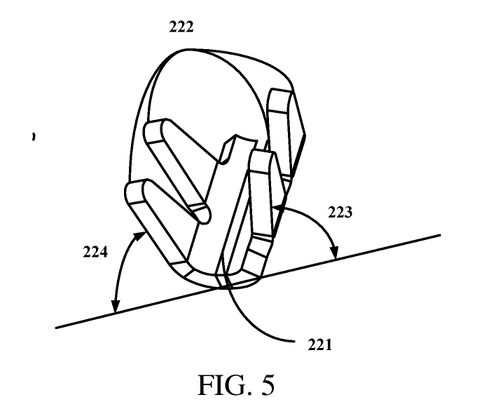

FIG. 5 is a detailed structure drawing of the riveting zones 22 of the terminals of FIG. 2. Each of the riveting zones 22 comprises at least one clamping portion 222 and a holding portion 221. An angle (223, 224) between the clamping portions 222 and the holding portion 221 is between 0-90 degrees.

In the embodiment, the first terminals 11 are fixed in the first body 10 corresponding to the fixing zones 21 of the first slots 17. Moreover, the first terminals 11 are embedded into the first body 10 from a back side of the first body 10. In other words, firstly, the first terminals 11 are fixed in the first body 10. Then, part of the projections 31 of the back cover 16 are connected with the first body 10 to fix the back cover 16 on the first body 10 from the back side of the first body 10 and positionally in accordance with part of the first slots 17. Each of the first terminals 11 and the second terminals 12 will fix in each of the guiding slots 161 of the back cover 16. Finally, a space between the second terminals 12, the fixing areas 151 of the second body 15, and the first body 10 is filled by colloid or the space is plugged with the back cover 16, avoiding problems during signal transfer caused by excess glue in the contacting zones 20 of the terminals 13 left by injection molding.

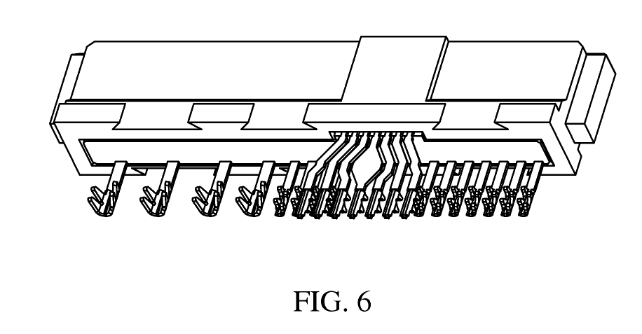

FIG. 6 is a packaged schematic view of a cable connector of a first preferred embodiment of the present invention. In the drawing, the first terminals 11 and the second terminals 12 are all embedded into the first body 10. The back cover 16 is also assembled in the first body 10.

The difference between the present invention and the prior art is disposing the riveting zones 22 on one side of the first terminals 11 and the second terminals 12. By adjusting the intervals between the terminals 13 (the first terminals 11 and the second terminals 12), the process of assembling the terminals 13 (the first terminals 11 and the second terminals 12) and the wires 23 can be done with a riveting machine, rather than by labor intensive welding, as is required in the prior art.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

1. A cable connector comprising:
a first body comprising a plurality of first slots and a plurality of second slots;
a plurality of terminals comprising a plurality of first terminals and a plurality of second terminals, each of the first terminals and the second terminals having a contacting zone, a fixing zone, and a riveting zone, and each of the fixing zones of the first terminals and the second terminals is embedded respectively in the first slots and the second slots of the first body from a back side of the first body, there are a plurality of first intervals between the riveting zones of the second terminals and a plurality of second intervals between the contacting zones of the second terminals, and the first intervals are larger than or equal to the second intervals; and
a plurality of wires, each of the wires having a connecting part corresponding to one of the riveting zones of the first terminals and the second terminals and a part of some of the wires are covered by insulating layers, wherein the connecting parts of the wires are connected with the riveting zones of the corresponding terminals,
wherein the riveting zone comprises a holding portion and a clamping portion bent upwards to clamp the connecting part of the wire.

2. The cable connector according to claim 1, wherein the second terminals further comprises a plurality of connecting zones between the riveting zones and the contacting zones of the second terminals, a length of the connecting zone of one of the second terminals and a length of the adjacent connecting zone are the same.

3. The cable connector according to claim 2, wherein part of each of the second terminals between the contacting connecting zone and the riveting zone is bending line shaped or curving line shaped.

4. The cable connector according to claim 3, wherein at least one of the second terminals comprises at least one bending zone disposed between each of the fixing zones and each of the riveting zones in order to make each of the fixing zones and each of the riveting zones be disposed on different horizontal planes.

5. The cable connector according to claim 1, wherein the contacting zones of part of the first terminals are electrically connected with the riveting zones of part of the first terminals by the method of many to one.

6. The cable connector according to claim 1, wherein the cable connector further comprises a back cover, the back cover comprises a plurality of guiding slots corresponding to the first terminals and the second terminals to make each of the first terminals and the second terminals be embedded respectively into each of the guiding slots.

7. The cable connector according to claim 6, wherein a space between the second terminals, the fixing areas, and the first body is filled by colloid or the space is plugged by a back cover.

8. The cable connector according to claim 6, wherein the back cover further comprises a plurality of projections, the projections are positionally in accordance with the first slots and the second slots.

9. A cable connector comprising:
a back cover comprising a plurality of projections;
a first body comprising a plurality of first slots and a plurality of second slots;
a plurality of terminals comprising a plurality of first terminals and a plurality of second terminals, each of the first terminals and the second terminals having a contacting zone, a fixing zone, and a riveting zone, and each of the fixing zones of the first terminals and the second terminals is embedded respectively in the first slots and the second slots of the first body from a back side of the first body, there are a plurality of first intervals between the riveting zones of the second terminals and a plurality of second intervals between the contacting zones of the second terminals, and the first intervals are larger than or equal to the second intervals, each of the fixing zones and each of the riveting zones are disposed on different horizontal planes, the second terminals further comprise a plurality of connecting zones between the riveting zones and the contacting zones of the second terminals, a length of the connecting zone of one of the second terminals and a length of the adjacent connecting zone are the same; and
a plurality of wires, each of the wires having a connecting part corresponding to one of the riveting zones of the first terminals and the second terminals, and a part of some of the wires are covered by insulating layers, wherein the connecting parts of the wires are connected with the riveting zones of the corresponding terminals,
wherein the riveting zone comprises a holding portion and a clamping portion bent upwards to clamp the connecting part of the wire.

10. The cable connector according to claim 9, wherein part of each of the second terminals between the contacting zone and the riveting zone is bending line shaped or curving line shaped.

11. The cable connector according to claim 9, wherein at least one of the second terminals comprises at least one bending zone disposed between each of the fixing zones and each of the riveting zones in order to make each of the fixing zones and each of the riveting zones be on different horizontal planes.

12. The cable connector according to claim 9, wherein the contacting zones of part of the first terminals are electrically connected with the riveting zones of part of the first terminals by the method of many to one.

13. The cable connector according to claim 9, wherein the cable connector further comprises a back cover, the back cover comprises a plurality of guiding slots corresponding to the first terminals and the second terminals to make each of the first terminals and the second terminals be embedded respectively into each of the guiding slots

14. The cable connector according to claim 13, wherein a space between the second terminals, the fixing areas, and the first body is filled by colloid or the space is plugged by a back cover.

15. The cable connector according to claim 13, wherein the back cover further comprises a plurality of projections, the projections are positionally in accordance with the first slots and the second slots.
